(19) United States
(12) Patent Application Publication
(10) Pub. No.: US 2008/0311952 A1
(43) Pub. Date: Dec. 18, 2008

(54) Local broadcast channel selection control for mobile handset

(76) Inventor: Edward Masami Sugiyama, Vancouver, WA (US)

Correspondence Address: SHARP LABORATORIES OF AMERICA, INC., 1320 PEARL ST., SUITE 228, BOULDER, CO, 80302, US

(21) Appl. No.: 11/811,998

(22) Filed: Jun. 13, 2007

(51) Int. Cl. H04N 5/445; H04B 1/38; H04N 7/00; H04N 7/173; H04M 1/00

(52) U.S. Cl. 455/556.1; 348/460; 455/73; 725/109; 725/25; 725/38; 348/E07.033

(57) ABSTRACT

A mobile handset and method therefor automatically limit user selection of local broadcast channels to those that are active. Location-related information sourced by an external node, such as RNSS position information from RNSS satellites or a cellular identification value sourced by a network access node, and received on the handset is applied to identify active local TV channels and the mobile handset limits selection of local TV channels by a user of the mobile handset to the active local TV channels. Identification of active local TV channels includes a first instance identification based on a lookup operation performed on the mobile handset and a second instance identification based on an active channel query/response exchange between the mobile handset and a server node, wherein the second instance identification is applied to update the first instance identification.

### BACKGROUND OF THE INVENTION

The present invention relates to local broadcast channel viewing on a mobile handset and, more particularly, to a mobile handset that automatically restricts selection of local broadcast channels to those channels that are actively broadcasting.

Local TV shows are broadcast over-the-air from terrestrial base stations over a limited geographic area via analog or digital TV signals. A mobile handset, such as a cellular phone, audio/visual player, personal data assistant (PDA) or pocket PC, that is within the geographic area and equipped with a TV antenna and suitable TV tuner can process these TV signals and render local TV shows on a display of the handset.

Local TV shows can be broadcast on very high frequency (VHF) channels 2-13 and ultra high frequency (UHF) channels 14-69. However, in a given geographic area only a few of these channels may be actively broadcasting. Thus, requiring a mobile handset user to search through all channels to find a desired TV show is highly inefficient.

To correct this inefficiency, some mobile handsets equipped with TV antennas and tuners allow the user to identify the geographic area where the user is located through user inputs. Based on these user inputs, these handsets reduce the channels selectable by the user to those determined by the handset to be actively broadcasting in the area. Accordingly, the user is no longer required to search all channels.

Inefficiencies remain in the above approach, however. First, the user is required to identify the geographic area where he or she is located through user inputs. Inputting such information requires geographic knowledge on the part of the user and consumes the user's valuable time. Moreover, the user must update the information whenever the user moves to a different geographic area. Second, the list of channels presumed by the handset to be active in a geographic area may become obsolete over time. If the handset is not updated to account for changes in the channels actively broadcasting in a geographic area, the handset may prevent the user from selecting active channels and allow the user to select discontinued channels.

### SUMMARY OF THE INVENTION

The present invention, in a basic feature, provides a mobile handset and methods for use therein that automatically limit user selection of local broadcast channels to those that are active.

In one aspect, the present invention provides a mobile handset comprising a processor, a user interface communicatively coupled with the processor and a radio navigation satellite system (RNSS) receiver communicatively coupled with the processor, wherein the RNSS receiver is adapted to determine position information and transmit the position information to the processor, and wherein the processor is adapted to identify active local TV channels based at least in part on the position information and limit access to local TV channels on the user interface to the active local TV channels.

In another aspect, the present invention provides a mobile handset comprising a processor, a user interface communicatively coupled with the processor and a wireless network interface communicatively coupled with the processor, wherein the processor is adapted to receive locally sourced information via the wireless network interface, identify active local TV channels based at least in part on locally sourced information and limit selection of local TV channels on the user interface to the active local TV channels.

In yet another aspect, the present invention provides a method for regulating selection of local TV channels on a mobile handset comprising the steps of receiving on the mobile handset location-related information sourced by one or more first external communication nodes, identifying by the mobile handset active local TV channels based at least in part on the location-related information and limiting by the mobile handset selection of local TV channels by a user of the mobile handset to the active local TV channels.

In some embodiments, identification of active local TV channels by the mobile handset includes a first instance identification based on a lookup operation performed on the mobile handset and a second instance identification based on an active channel query/response exchange between the mobile handset and a server node, wherein the mobile handset applies the second instance identification to update the first instance identification.

Naturally, the principles of the invention may readily extend to other types of channelized local broadcasts, such as AM and FM radio channel broadcasts.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a communication system in which local TV channel selection control on a mobile handset is operative in some embodiments of the invention.

FIGS. 2A and 2B show exemplary channel selection menu screens rendered on a user interface of a mobile handset in some embodiments of the invention.

FIG. 3 shows a method for regulating selection of local TV channels on a mobile handset in some embodiments of the invention.

### DETAILED DESCRIPTION OF A PREFERRED EMBODIMENT

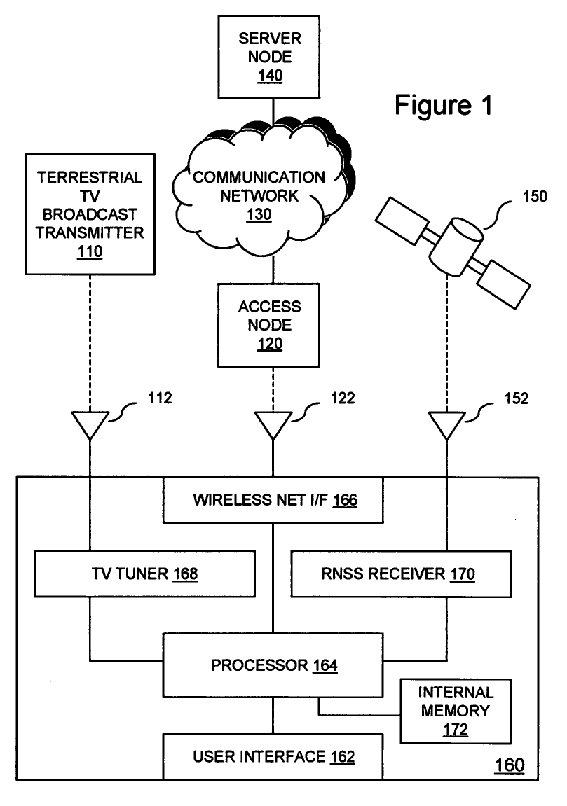

In FIG. 1, a communication system in which local TV channel selection control on a mobile handset is operative in some embodiments of the invention is shown. The system includes a mobile handset 160 communicatively coupled with a terrestrial TV broadcast transmitter 110, an access node 120 and RNSS satellites 150 via antennas 112, 122 and 152, respectively.

Broadcast transmitter 110 is a land-based transmitter adapted to broadcast analog or digital TV signals over the air to a limited geographic area on a VHF or UHF channel. An arbitrary number of land-based repeaters may be deployed to propagate the signals throughout the limited geographic area. While only one transmitter 110 is shown, it will be appreciated that in the given geographic area where handset 160 currently resides there are typically multiple active transmitters transmitting different TV shows on different channels.

Access node 120 is a telecommunications network access node, such as a cellular base station or a wireless access point, local to handset 160 and providing handset 160 with bidirectional access via a wireless link to nodes within communication network 130 using an air interface protocol such as General Packet Radio Services (GPRS), Code Division Multiple Access (CDMA), Evolution Data Optimized (EV-DO), High-Speed Downlink Protocol Access (HSDPA), Internet Protocol (IP) or IEEE 802.11 (Wi-Fi), for example. Communication network 130 is a network that includes an arbitrary number of multiplexing nodes, such as switches and routers, supporting data flows between handset 160 and a server node 140. Server node 140 is a computing node that may be remote from handset 160 and is adopted to store external local active TV channel lists for different TV coverage areas. Server node 140 is adapted to deliver to handset 160 externally generated local active TV channel lists for different TV coverage areas in response to active channel queries received from handset 160 for different TV coverage areas. Naturally, communication network 130 may support communication between handset 160 and other wired and wireless client and server nodes.

RNSS satellites 150 are Earth-orbiting satellites that broadcast signals from which handset 160 is able to determine its geographic position through trilateration. In some embodiments, RNSS components described herein are global positioning system (GPS) components and RNSS information described herein is GPS information.

Mobile handset 160 is a portable handheld electronic device, such as a cellular phone, a digital audio/video player, a PDA, or a pocket PC, for example. Handset 160 includes a user interface 162, a wireless network interface 166, a TV tuner 168, an RNSS receiver 170 and an internal memory 172, all of which are communicatively coupled with a processor 164. Processor 164 is adapted to execute device software stored in internal memory 172 and interoperate with elements 162, 166, 168, 170 and 172 to perform various features and functions supported by handset 160, including the methods and systems for regulating selection of local TV channels on a mobile handset described herein. In some embodiments, processor 164 comprises a single processing unit. In other embodiments, processor 164 comprises multiple processing units.

User interface 162 is adapted to transmit outputs and receive inputs from a human user of handset 160. User interface 162 may, for example, include an output mechanism such as a liquid crystal display (LCD) and loudspeaker, a display driver and an input mechanism such as a keypad or touch-sensitive navigation tool. The display driver may be implemented in one or more application specific integrated circuits (ASICs), for example. The output mechanism is adapted to render local TV shows broadcast by a terrestrial TV broadcast transmitter, such as transmitter 110, and render information indicative of local TV channels that are selectable by the user. The input mechanism is adapted to receive selections of local TV channels made by the user.

Wireless network interface 166 is adapted to process data signals transmitted and received from access node 120 via bidirectional antenna 122 in accordance with a wireless communication protocol, such as a cellular or wireless LAN protocol. Wireless network interface 166 may be implemented in one or more ASICS, for example. Transmitted data signals include active channel queries originated on handset 160 and destined for server node 140. Received data signals include responses to active channel queries originated on server node 140 and destined for handset 160. In some embodiments, received data signals also include information sourced by access node 120, such as a mobile country code (MCC), mobile network code (MNC), location area code (LAC), cell ID, network ID or system ID, for example.

TV tuner 168 is adapted to process TV signals received from terrestrial TV broadcast transmitters, such as transmitter 110, via TV antenna 112. TV tuner 168 may be implemented in one or more ASICs, for example. In some embodiments, TV tuner 168 is adapted to process digital TV signals. In other embodiments, TV tuner 168 is adapted to process both analog and digital TV signals. Processing of TV signals by TV tuner 168 includes, for example, passing video and audio signals received on a VHF or UHF channel to which TV tuner 168 is presently tuned while filtering other signals, recovering video and audio data from passed TV signals, converting recovered video and audio data into an audio/video stream adapted for further processing by processor 164 and transmitting the audio/video stream to processor 164 for subsequent rendering on user interface 162. In embodiments where TV tuner 168 is adapted to process analog TV signals, processing also includes analog to digital conversion.

RNSS receiver 170 is adapted to process RNSS signals received from RNSS satellites 150 via RNSS antenna 152. RNSS receiver 170 may be implemented in one or more ASICs, for example. Processing of RNSS signals by RNSS receiver 170 includes, for example, determining the global position of handset 160 through trilateration and transmitting global position information to processor 164. In some embodiments, the global position information transmitted to processor 164 includes the longitude and latitude of handset 160.

Internal memory 172 is adapted to store device software and one or more lookup tables. Memory 172 may be implemented in a combination of read-only memory (ROM) and random access memory (RAM), for example. In some embodiments, memory 172 includes a flash memory. The device software includes instructions adopted for execution by processor 164. Generally speaking, the lookup tables are adopted to map information received by processor 164 directly or indirectly to internally maintained active local TV channel lists.

In some embodiments, internal memory 172 includes a channel resolution lookup table storing mappings between position information received from RNSS receiver 170 and internally maintained active local TV channel lists that correspond to the position information. In these embodiments, position information is applied to the channel resolution lookup table to obtain an internally generated active local TV channel list that corresponds to the position information.

In some embodiments, internal memory 172 includes a channel resolution lookup table storing mappings between one or more cellular identification values sourced by access node 120, such as MCC, MNC, LAC, cell ID, network ID or system ID, and internally maintained active local TV channel lists that correspond to the cellular identification values. In these embodiments, one or more cellular identification values is applied to the channel resolution lookup table to obtain an internally generated active local TV channel list that corresponds to the cellular identification values.

In some embodiments, internal memory 172 includes a location resolution lookup table and a channel resolution lookup table. The location resolution lookup table stores mappings between position information received from RNSS receiver 170 and local TV coverage areas. The channel resolution lookup table stores mappings between local TV coverage areas and internally maintained active local TV channel lists. In these embodiments, position information is applied to the location resolution table to obtain a local TV coverage area and the local TV coverage area is thereafter applied to the channel resolution lookup table to obtain the internally generated active local TV channel list that corresponds to the local TV coverage area.

In some embodiments, internal memory 172 includes a location resolution lookup table and a channel resolution lookup table. The location resolution lookup table stores mappings between one or more cellular identification values sourced by access node 120 and local TV coverage areas. The channel resolution lookup table stores mappings between local TV coverage areas and internally maintained active local TV channel lists. In these embodiments, one or more cellular identification values is applied to the location resolution table to obtain a local TV coverage area and the local TV coverage area is thereafter applied to the channel resolution lookup table to obtain an internally generated active local TV channel list that corresponds to the local TV coverage area.

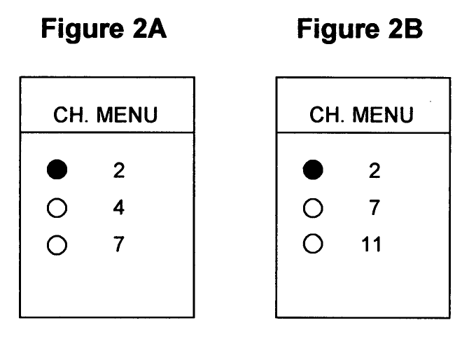

Turning to FIGS. 2A and 2B, exemplary channel selection menu screens rendered on user interface 162 of in some embodiments of the invention are shown. The screens represent sequential states of the channel selection menu. Turning first to FIG. 2A, a channel selection menu based on an internally generated active local TV channel list is shown. The menu includes three selectable channels: 2, 4 and 7. Turning next to FIG. 2B, a channel selection menu updated based on an externally generated active local TV channel list is shown. The menu still includes three selectable channels. However, the selectable channels are now 2, 7 and 11, reflecting recent commencement of local TV broadcasts on channel 11 and recent discontinuation of TV broadcasts on channel 7. Processor 164 causes user interface 162 to transition from the user screen of FIG. 2A to the user screen of FIG. 2B after the externally generated active local TV channel list is acquired from server node 140.

It will be appreciated that TV channels in some embodiments may be identified using information in addition to or other than channel numbers, such as station names.

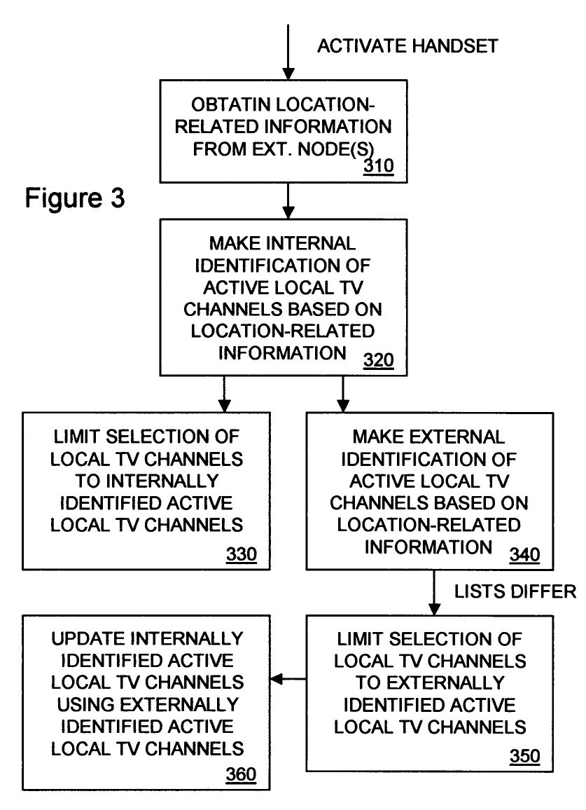

Turning to FIG. 3, a method is shown for regulating selection of local TV channels on a mobile handset in some embodiments of the invention. A user activates handset 160 in response to which handset 160 obtains location-related information from one or more external communication nodes (310). In some embodiments, location-related information includes RNSS signals received from RNSS satellites 150. In other embodiments, location-related information includes cellular identification values received from access node 120 via wireless network interface 166.

An internal identification of local active TV channels is then made based at least in part on the location-related information (320). In some embodiments, RNSS receiver 170 resolves position information from RNSS signals and processor 164 applies the position information or a local TV coverage area looked-up based on the position information to a channel resolution lookup table in internal memory 172 obtain an internally generated local active TV channel list. In other embodiments, processor 164 applies one or more cellular identification values received from access node 120 or a local TV coverage area looked-up based on the cellular identification values to a channel resolution lookup table in internal memory 172 to obtain an internally generated local active TV channel list.

Selection of local TV channels is then limited to the internally identified active local TV channels (330). In some embodiments, processor 164 limits user selection of local TV channels on a menu displayed on user interface 162 to those within the internally generated local active local TV channel list obtained in Step 320. In other embodiments, processor 164 bypasses local TV channels on user interface 162 that are not within the internally generated local active TV channel list obtained in Step 320. For example, when the user uses a “channel up” or “channel down” feature on user interface 162 for channel selection, local TV channels that are not within the internally generated local active local TV channel list are skipped.

Simultaneously, an external identification of local active TV channels is made based at least in part on the location-related information (340). In some embodiments, processor 164 originates an active channel query based at least in part on position information received from RNSS receiver 170 or a local TV coverage area looked-up internally based on the position information and transmits the query to server node 140, in response to which server node 140 returns an externally generated active local TV channel list. In other embodiments, processor 164 originates an active channel query based at least in part on one or more cellular identification values received from access node 120 via wireless interface 166 or a local TV coverage area looked-up internally based on the cellular identification values and transmits the query to server node 140, in response to which server node 140 returns an externally generated active local TV channel list.

If the internally and externally generated active local TV channel lists differ, selection of local TV channels is then limited to the externally identified active local TV channels (350). In some embodiments, processor 164 limits user selection of local TV channels on a channel menu displayed on user interface 162 to the active local TV channels identified in the externally generated active local TV channel list. In other embodiments, processor 164 bypasses local TV channels on user interface 162 that are not among the active local TV channels identified in the query response. For example, when the user uses a “channel up” or “channel down” feature on user interface 162 for channel selection, local TV channels that are not within the externally generated active local TV channel list are skipped. Moreover, the internally maintained active local TV channel list is updated for future reference using the externally generated active local TV channel list (360). Naturally, if the internally and externally identified active local TV channel lists do not differ, Steps 350 and 360 are obviated.

It will also be appreciated by those of ordinary skill in the art that the invention can be embodied in other specific forms without departing from the spirit or essential character hereof. As one example, the invention in some embodiments is applied to regulate user selection of local radio channels rather than TV channels. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile handset, comprising
a processor;
a user interface communicatively coupled with the processor; and
a radio navigation satellite system (RNSS) receiver communicatively coupled with the processor, wherein the RNSS receiver is adapted to determine position information and transmit the position information to the processor, and wherein the processor is adapted to identify active local broadcast channels based at least in part on the position information and limit selection of local broadcast channels on the user interface to the active local broadcast channels.

2. The mobile handset of claim 1, further comprising:
an internal memory communicatively coupled with the processor, wherein the processor is adapted identify the active local broadcast channels based at least in part on a lookup operation performed in the internal memory.

3. The mobile handset of claim 1, further comprising:
a wireless network interface communicatively coupled with the processor, wherein the processor is adapted identify the active local broadcast channels based at least in part on transmitting to a server node via the wireless network interface an active channel query and receiving from the server node via the wireless network interface in response to the active channel query information indicative of the active local broadcast channels.

4. The mobile handset of claim 1, further comprising:
an internal memory communicatively coupled with the processor, wherein the processor is adapted identify the active local broadcast channels in a first instance based at least in part on a lookup operation performed in the internal memory; and
a wireless network interface communicatively coupled with the processor, wherein the processor is adapted to identify the active local broadcast channels in a second instance based at least in part on transmitting to a server node via the wireless network interface an active channel query and receiving from the server node via the wireless network interface in response to the active channel query information indicative of the active local broadcast channels.

5. The mobile handset of claim 4, wherein the processor updates the active local broadcast channels identified in the first instance using the active local broadcast channels identified in the second instance.

6. The mobile handset of claim 1, wherein the processor is adapted to limit selection of local broadcast channels on the user interface to the active local broadcast channels by limiting user selection of local broadcast channels on a channel menu displayed on the user interface to the active local broadcast channels.

7. The mobile handset of claim 1, wherein the processor is adapted to limit selection of local broadcast channels on the user interface to the active local broadcast channels by passing local broadcast channels on the user interface that are not among the active local broadcast channels.

8. The mobile handset of claim 1, wherein the local broadcast channels are television channels.

9. A mobile handset, comprising:
a processor;
a user interface communicatively coupled with the processor; and
a wireless network interface communicatively coupled with the processor, wherein the processor is adapted to receive locally sourced information via the wireless network interface, identify active local broadcast channels based at least in part on locally sourced information and limit selection of local broadcast channels on the user interface to the active local broadcast channels.

10. The mobile handset of claim 9, further comprising:
an internal memory communicatively coupled with the processor, wherein the processor is adapted identify the active local broadcast channels based at least in part on a lookup operation performed in the internal memory.

11. The mobile handset of claim 9, wherein the processor is adapted identify the active local broadcast channels based at least in part on transmitting to a server node via the wireless network interface an active channel query and receiving from the server node via the wireless network interface in response to the active channel query information indicative of the active local broadcast channels.

12. The mobile handset of claim 9, further comprising:
an internal memory communicatively coupled with the processor, wherein the processor is adapted identify the active local broadcast channels in a first instance based at least in part on a lookup operation performed in the internal memory, and wherein the processor is adapted to identify the active local broadcast channels in a second instance based at least in part on transmitting to a server node via the wireless network interface an active channel query and receiving from the server node via the wireless network interface in response to the active channel query information indicative of the active local broadcast channels.

13. The mobile handset of claim 12, wherein the processor updates the active local broadcast channels identified in the first instance using the active local broadcast channels identified in the second instance.

14. The mobile handset of claim 9, wherein the locally sourced information is sourced by a network access node communicatively coupled to the mobile handset via a wireless link.

15. The mobile handset of claim 9, wherein the locally sourced information comprises cellular identification values.

16. The mobile handset of claim 9, wherein the processor is adapted to limit selection of local broadcast channels on the user interface to the active local broadcast channels by limiting user selection of local broadcast channels on a channel menu displayed on the user interface to the active local broadcast channels.

17. The mobile handset of claim 9, wherein the processor is adapted to limit selection of local broadcast channels on the user interface to the active local broadcast channels by passing local broadcast channels on the user interface that are not among the active local broadcast channels.

18. The mobile handset of claim 10, wherein the local broadcast channels are television channels.

19. A method for regulating selection of local TV channels on a mobile handset, comprising the steps of:
receiving on the mobile handset location-related information sourced by one or more first external communication nodes;
identifying by the mobile handset active local TV channels based at least in part on the location-related information; and
limiting by the mobile handset selection of local TV channels by a user of the mobile handset to the active local TV channels.

20. The method of claim 19, wherein the identifying step comprises the steps of:
identifying the active local TV channels in a first instance based at least in part on a lookup operation performed on the mobile handset;
identifying the active local TV channels in a second instance based at least in part on transmitting from the mobile handset to a server node an active channel query and receiving on the mobile handset from the server node in response to the active channel query information indicative of the active local TV channels; and
updating on the mobile handset the active local TV channels identified in the first instance using the active local TV channels identified in the second instance.
